(19) United States
(12) Patent Application Publication
(10) Pub. No.: US 2010/0243916 A1
(43) Pub. Date: Sep. 30, 2010

(54) MODULAR OPTICAL DIAGNOSTIC PLATFORM FOR CHEMICAL AND BIOLOGICAL TARGET DIAGNOSIS AND DETECTION

(75) Inventors: Scott Maurer, Haymarket, VA (US); Stephanie Groves, Aldie, VA (US); Kee Koo, McLean, VA (US)

Correspondence Address: Howard IP Law Group, P.O. Box 226, Fort Washington, PA, 19034, US

(73) Assignee: Lockheed Martin Corporation, Bethesda, MD (US)

(21) Appl. No.: 12/729,996

(22) Filed: Mar. 23, 2010

Related U.S. Application Data
(60) Provisional application No. 61/164,844, filed on Mar. 30, 2009.

(51) Int. Cl. G01J 1/58; G01N 21/64; G06F 19/00; G01J 3/30

(52) U.S. Cl. 250/459.1; 250/458.1; 702/76; 356/317; 250/226; 250/237 G

(57) ABSTRACT

A modular system for optical diagnosis of a sample includes a portable optical probe, a light source, a filter, and a gain detector. A first optical element releasably, optically couples the optical probe to the light source. A second optical element releasably, optically couples the optical probe to the filter and a third optical element releasably, optically couples the filter to the gain detector. The optical probe receives an optical signal from the light source via the first optical element and directs the optical signal onto the sample, thereby inducing fluorescence emission from the sample. The optical probe receives the fluorescence emission from the sample and transmits to the filter via the second optical element. The filter transmits the fluorescence emission to the gain detector via the third optical element. The optical head includes a beam splitter which reflects the fluorescence emission from the sample to the filter.

### CROSS-REFERENCE TO RELATED APPLICATION

The present application claims the benefit of the U.S. Provisional Patent Application Ser. No. 61/164,844, filed on Mar. 30, 2009, which application is incorporated by reference herein in its entirety.

### FIELD OF INVENTION

The present invention relates in general to chemical and biological target detection and identification, and more particularly, to fiber optic systems and apparatus therefor.

### BACKGROUND

Rapid and real-time detection of chemical and biological agents without the need for elaborate laboratory facilities is desirable for many applications, including medical and security applications. Generally, systems for DNA fingerprinting identification, cytometry, microscopy and fluorescence imaging, for example, have large footprints and require dedicated resources of a laboratory. Components of such systems generally require precision alignment for optical elements such as lenses and mirrors and may be specialized for a given application. Some microscopes such as electron microscopes require a partial vacuum to observe the specimen. Electron microscopes also require extremely stable high-voltages and currents supplied to each electromagnetic coil/lens, continuously pumped high or ultra-high vacuum systems, and a cooling water supply circulation through the lenses and pumps. Electron microscopes are also very sensitive to vibration and external magnetic fields and may, therefore, have to be appropriately isolated and shielded.

Other microscopes such as confocal microscopes have inherent resolution limitations due to diffraction. Resolution is typically limited to about 200 nm. Furthermore, some conventional systems, generally referred to as desktop systems, are large in size, non-modular, inflexible in nature and are relatively expensive. Alternative systems are desirable.

### SUMMARY OF THE INVENTION

According to an aspect of the present invention, a portable optical probe includes a scanning optical head which is operatively coupled to a translational stage adapted to receive a sample module containing a sample. The optical head includes a focusing lens. The focusing lens focuses an optical signal received from a light source onto the target sample in the sample module, to induce fluorescence emission from the sample. The optical head also includes a beam splitter serving as a wavelength multiplexer to reflect the fluorescence emission from the sample received at the focusing lens to an optical element in optical communication with the optical probe. Spatial probing of the sample may be accomplished by moving the entire optical head relative to the sample under test.

According to another embodiment of the invention, a portable optical probe includes an optical head. The optical head includes a focusing lens and a beam steering mechanism adapted to steer an optical beam from a light source onto the focusing lens. The focusing lens focuses the optical beam onto a selected location on a sample module, thereby inducing fluorescence emission from the sample contained in the sample module. The optical head also includes a beam splitter serving as a wavelength multiplexer to reflect the fluorescence emission to an optical element in optical communication with the optical probe. The optical element, such as a spectral multiplexer may be a part of the optical probe head or may be separately (i.e. modularly) connected to the head (and located remotely therefrom) by means of an optical fiber interconnect. Spatial probing of the sample may be accomplished by the beam steering mechanism. A combination of beam steering and optical head translation may be utilized to extend the spatially scannable range of the assembly.

According to another embodiment of the invention, a modular system for optical diagnosis of a sample includes a portable scanning optical probe, a light source and a first optical element releasably, optically coupling the scanning optical probe to the light source. The optical probe receives an optical signal from the light source via the first optical element and directs the optical signal onto a sample contained in a sample module. The system further includes a filter and a second optical element releasably, optically coupling the filter to the optical probe. The system also includes a gain detector and a third optical element releasably, optically coupling the gain detector to the filter. The scanning optical probe includes a micro-optic fiber tip adapted to transmit an optical signal onto the sample module containing the sample, thereby inducing fluorescence emission from the sample, and to receive the fluorescence emission from the sample. The optical probe transmits the fluorescence emission to the filter via the second optical element and the filter transmits the fluorescence emission to the gain detector. The gain detector outputs a fluorescence signature indicative of the identity of at least one constituent of the sample.

An aspect of the invention includes a method for optical interrogation of a sample contained in a microfluidic chip comprising the steps of injecting a sample in a channel of the microfluidic chip. The channel containing the sample is scanned with a scanning optical probe which is releasably, optically coupled to a light source. Fluorescence is induced in the sample by illuminating the sample with an optical signal from the light source. The fluorescence emission from the sample is received at the scanning optical probe which is releasably, optically coupled to an optical analyzer and a gain detector. The fluorescence emission received at the scanning optical probe is transmitted to the optical analyzer and the gain detector.

According to an aspect of the invention, the method further comprises the steps of spectrally analyzing the received fluorescence emission using the optical analyzer and detecting a fluorescence signature of a target contained in the sample using the gain detector.

### BRIEF DESCRIPTION OF THE DRAWINGS

Understanding of the present invention will be facilitated by consideration of the following detailed description of the exemplary embodiments of the present invention taken in conjunction with the accompanying drawings, in which like numerals refer to like parts and in which:

FIG. 1 is a schematic diagram of a compact target fluorescence detection system, according to an embodiment of the invention;

FIG. 2A is an optical beam steering and focusing mechanism for use with the system of FIG. 1, according to an embodiment of the invention;

FIG. 2B is an optical beam steering and focusing mechanism for use with the system of FIG. 1, according to another embodiment of the invention;

FIG. 3 is a schematic diagram of a scanning optical head for scanning a target sample using an optical beam steering mechanism of FIG. 2B, according to an embodiment of the invention;

FIG. 4A illustrates schematically a compact target fluorescence detection system including a lab-on-a-chip target extractor and a fluorescence probe, according to an embodiment of the invention;

FIG. 4B is an exemplary fluorescence signature as detected by the system of FIG. 4A, according to an embodiment of the invention;

FIG. 4C is an exemplary detector output from the system of FIG. 4A, according to an embodiment of the invention;

FIG. 5A is an exemplary embodiment of a microfluidic chip having multiple channels for use in conjunction with a scanning optical probe of the system of FIG. 1, according to an embodiment of the invention;

FIG. 5B illustrates a plot depicting an exemplary response from the optical interrogation of the microfluidic chip of FIG. 5A using a scanning optical probe of the system of FIG. 1, according to an embodiment of the invention;

FIG. 5C illustrates a time response plot generated from the output of the scanning optical probe of the system of FIG. 1 interrogating the microfluidic chip of FIG. 5A, according to an embodiment of the invention;

FIG. 5D illustrates a plan view of an exemplary embodiment of a microfluidic chip having multiple channels for use in conjunction with a scanning optical probe of the system of FIG. 1, according to another embodiment of the invention;

FIG. 6 illustrates a micro-optic fiber-tip fluorescent probe and modular fiber optic interconnects, according to another embodiment of the invention; and

FIG. 7 illustrates a process flow for optical interrogation of an agent by inducing fluorescence, according to an embodiment of the invention.

### DETAILED DESCRIPTION

It is to be understood that the figures and descriptions of the present invention have been simplified to illustrate elements that are relevant for a clear understanding of the present invention, while eliminating, for purposes of clarity, many other elements found in typical DNA analyzer systems and fluorescence signature detection systems. However, because such elements are well known in the art, and because they do not facilitate a better understanding of the present invention, a discussion of such elements is not provided herein. The disclosure herein is directed to all such variations and modifications known to those skilled in the art.

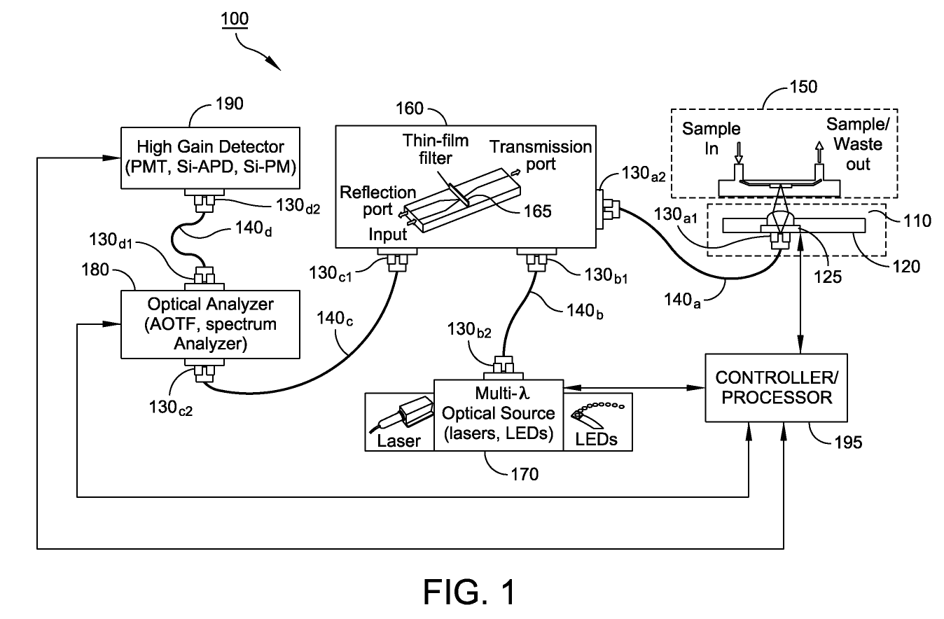

Referring to FIG. 1, there is illustrated an exemplary modular system 100 for chemical or biological target diagnosis and detection using fluorescence signature detection, according to an embodiment of the invention. System 100 includes an optical probe 110, a sample module 150, a light source 170, an optical coupler 160, an optical analyzer 180, a gain detector 190, and a controller/processor 195. Each of these components of system 100 has an optical connector 130, designated individually 130ₐ₁, 130ₐ₂, and so on for each component. Optical connector 130 is adapted to receive and releasably secure a complementary connector on an end of an optical element 140, designated individually as 140ₐ, 140_{b}, and so on. In an exemplary configuration, controller/processor 195 may take the form of a general or a special purpose computer and may include an integrated computerized digital signal processor and a data acquisition card (not shown) coupled to detector 190. In the illustrated embodiment, controller 195 serves to control light source 170, optical probe 110, analyzer 180 and detector 190. A data acquisition card may include a plug-in data acquisition card which may be plugged directly into the chassis of a computer and may include one or more analog inputs and outputs, and one or more digital inputs and outputs. Examples of suitable hardware data acquisition systems include those produced by industry vendors such as National Instruments, AD Instruments, and Fluke, which may be controlled with the respective vendor's data acquisition software suites such as LabVIEW, LabChart, and NetDAQ. Integration of the data acquisition controller (e.g. NI CompactRIO) with a higher level system processor in a small form factor is well known and may include small embedded, real-time controllers, and field-programmable gate arrays (FPGAs) for system control as well. Since such controllers, digital signal processors and data acquisition cards and systems are known in the art, controller/processor 195 is not described in further detail for the sake of brevity.

In an exemplary embodiment, optical element 140 is a single mode optical fiber. In another embodiment, optical element 140 may be a multi-mode optical fiber. In one configuration, optical element 140 may be a flexible optical fiber or a fiber-optic cable. Optical elements 140 may be connectorized with suitable standardized connectors such as LC connector, SC connectors, and MT connectors at their ends to facilitate easy coupling and decoupling with optical connectors 130. Other types of optical fiber connectors known in the art may also be used. The use of connectorized optical element 140 to connect various components of system 100 enables easy and rapid assembly and disassembly of system 100. Another advantage of the use of optical element 140 is the flexibility available in packaging as well as placement of these components of system 100 relative to one another during an operational state. Conventionally, the optical communication between these components would require precise alignment of lenses and mirrors, and therefore their relative positions are at least somewhat constrained. In contrast, the use of flexible optical elements 140 in the present invention obviates the need for such lenses and mirrors and provides an added degree of flexibility in the placement, connection and packaging of these components. The use of optical elements 140 also provides portability since different modules may be packaged and handled independently and may be releasably coupled to one another on site.

In one configuration, optical probe 110 may be a compact and portable probe. In another configuration, optical probe 110 may be a hand-held probe. A movable or scanning optical probe 110 includes a translational stage 120 and an optical head 125. In an exemplary embodiment, translational stage or mechanical stage 120 takes the form of a flat bed. By way of non-limiting example, translational stage or mechanical stage 120 has a width of about 100 millimeters (mm) and a length of about 125 mm. Optical head 125 is movably coupled to translational stage 120. Optical head 125 is adapted to translate along at least two orthogonal directions provided by the translational stage 120. The direction and the speed of the movement of optical head 125 may be controlled via controller 195 (e.g. a computer processor). Travel mechanisms for coupling such optical heads and translational stages are known in the art and are, therefore, not described in further detail. An alternative to using mechanical stages to provide relative motion of optical head 125 for sample scanning is to use a beam steering mechanism disposed within optical head 125 that steers the interrogating optical signal over the target sample. The use of either a movable optical head 125 (relative to the sample) or a beam steering mechanism within optical head 125 enables spatial probing of the sample. Optical head 125 has a connector 130ₐ₁. Connector 130ₐ₁ is adapted to receive and releasably secure a connectorized end of optical element 140ₐ. In the illustrated embodiment, optical head 125 is in optical communication with optical coupler 160 via optical element 140ₐ. Optical probe 110 receives an input optical signal from optical coupler 160 as well as transmits a fluorescence signal induced by the input optical signal in the sample and received from the sample to an optical element, for example, optical coupler 160.

Referring still to FIG. 1, optical coupler 160 optically, releasably couples optical probe 110 to light source 170 via connectorized optical element 140_{b} and to optical analyzer 180 via connectorized optical element 140_{c} in the illustrated embodiment. A connector 130ₐ₂ on coupler 160 receives and releasably secures a connectorized end of optical element 140_{b}. Another connector 130_{c1} receives and releasably secures a connectorized end of optical element 140, thereby releasably coupling coupler 160 to analyzer 180. Yet another connector 130_{b1} receives and releasably secures a connectorized end of optical element 140_{b}, thereby releasably coupling coupler 160 to light source 170. Coupler 160 receives an optical signal from light source 170 via an input port optically coupled to optical element 140_{b} and transmits the optical signal to optical probe 110 via a transmission port optically coupled to optical element 140ₐ. In one configuration, coupler 160 is a fiber-optic wavelength division multiplex (WDM) coupler. In an exemplary embodiment, coupler 160 includes a thin film spectral splitter 165. Thin film spectral splitter 165 is adapted to selectively transmit a light of only a given wavelength or a wavelength band from multi-wavelength light source 170 to optical probe 110. Thin-film spectral splitter 165 is also adapted to transmit, via optical element 140_{c} connected thereto, to optical analyzer 180, the fluorescence emission, received by optical probe 110 and transmitted to coupler 160.

In one configuration, thin-film spectral splitter 165 is a dichroic filter. As is known in the art, a dichroic film is adapted to reflect light over a certain predetermined range of wavelengths, and to transmit light which is outside that range. Such a thin-film spectral splitter 165 may be coated with suitable optical coatings known in the art. Thin-film spectral splitter 165 may thus be adapted to transmit light of only certain selective wavelengths from light source 170 to optical probe 110, depending on the specific requirements of the application. Thin-film spectral splitter 165 may also be adapted to transmit fluorescence emission received from optical probe 110 to analyzer 180. Since coupler 160 is releasably coupled to optical probe 110, light source 170, and analyzer 180 using connectors 130ₐ₂, 130_{b1}, 130_{c1} respectively and connectorized, flexible optical elements 140ₐ, 140_{b}, 140_{c}, it is easy to replace or change optical coupler 160 depending on the demands of a particular application, thereby providing versatility and flexibility to system 100.

Still referring to FIG. 1, optical coupler 160 is optically coupled to light source 170 via connector 130_{b1} and connectorized flexible optical element 140_{b}. In one configuration, light source 170 may be a multi-wavelength light source. In another configuration, light source 170 may be a single wavelength light source. In an exemplary embodiment, light source 170 may be a miniaturized solid state laser source, such as diode-pumped solid-state lasers, adapted to emit light of different wavelengths (e.g. wavelengths ranging from about 400 nanometers (nm) to about 700 nm). In another exemplary embodiment, light source 170 may be a single module containing multiple wavelength Light Emitting Diodes (LEDs). The use of a multi-wavelength optical source 170 may broaden the scope of or enhance the capability of the fluorescence interrogation by facilitating the exposure of a sample to light of different wavelengths, either simultaneously or sequentially. Light source 170 has a connector 130_{b2}. Connector 130_{b2} is adapted to receive and releasably secure optical element 140_{b} which releasably couples light source 170 to optical coupler 160. Light source 170 may be controlled by controller 195 in the illustrated embodiment to emit light of one or more selective wavelengths. Light source 170 may be easily replaced or changed, depending on the specific requirements of different applications because optical element 140_{b} may be easily uncoupled from connector 130_{b2} of one light source 170 and may be easily coupled to another light source 170 having a similar connector 130. Thus, the use of connectorized optical elements 140 and connectors 130 provides versatility as well as flexibility to system 100. The use of flexible optical elements 140 also eliminates the need to precisely align light source 170 relative to optical coupler 160 and/or optical probe 110.

Optical coupler 160 is releasably, optically coupled to optical analyzer 180 via connector 130_{c1} and a first connectorized end of optical element 140_{c}. Optical analyzer 180 is releasably, optically coupled to optical coupler 160 via connector 130_{c2} and a second connectorized end of optical element 140. Thus, optical element 140 is releasably coupled to connector 130_{c2} of analyzer 180 and connector 130_{c1} of coupler 160, thereby releasably, optically connecting analyzer 180 to coupler 160. Analyzer 180 is used to examine the spectral composition of the received fluorescence emission. In one configuration, analyzer 180 is an acousto-optic tunable filter. As is known in the art, an acousto-optic tunable filter uses the acousto-optic effect to diffract and shift the frequency of light using sound waves. Alternatively, a set of fiber Bragg gratings can serve as optical spectral filters.

Analyzer 180 is releasably, optically coupled to a gain detector 190 via connectorized optical element 140_{d}. Optical element 140_{d} is releasably coupled to connector 130_{d1} of analyzer 180 and connector 130_{d2} of gain detector 190, thereby releasably, optically coupling analyzer 180 to gain detector 190. Gain detector 190 is used to detect the fluorescence signatures of one or more constituents of the sample. In one configuration, gain detector 190 takes the form of a photomultiplier tube (PMT). In another configuration, gain detector 190 may be an avalanche photodiode (APD), such as Si-APD. As is known in the art, internal current gain effect in the range from about 100 to very high gain of about 10⁵ to 10⁶ may be obtained using a Si-APD. An APD operating in a high-gain regime is useful for single photon detection. In an exemplary embodiment, an avalanche photodiode array may be arranged on a silicon substrate, which is commonly known as silicon photomultiplier (SiPM).

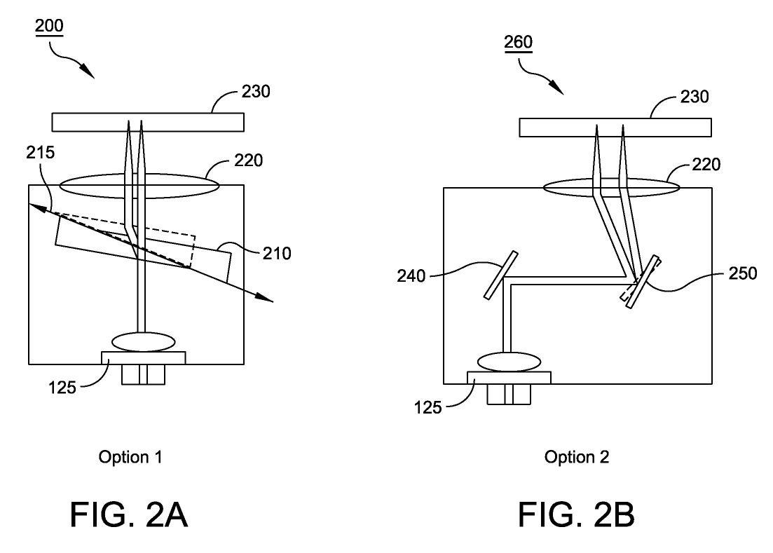

Referring now to FIGS. 2A-2B, two embodiments of optical beam steering and focusing mechanisms 200, 260, which may be included within optical probe 110, are illustrated. As described above, in an exemplary embodiment, optical probe 110 may include a mechanical or translational stage 120 relative to which optical head 125 moves to scan a sample module (not shown) disposed on stage 120. Another alternative is to use optical beam steering and focusing mechanisms 200, 260 to scan the sample module (not shown), thereby eliminating the need for a mechanical translational stage 120. In FIG. 2A, a pair of steering prisms 210 of mechanism 200 may be used to steer an optical beam onto a focusing lens 220. Focusing lens 220 focuses the optical beam on a sample platform 230, which receives the sample module (not shown). One or both of steering prisms 210 may be appropriately adjusted to selectively steer the optical beam onto different locations of focusing lens 220 and onto different locations of sample platform 230, without moving optical probe 110 or the sample module (not shown) on sample platform 230. Two prisms 210 are substantially identical and one prism is adapted to move relative to the other in order to provide a lateral position offset in the output optical beam. A first prism 210 may be moved relative to second prism 210 along their adjacent surfaces along a movable axis 215. As first prism 210 is moved along movable axis 215 relative to second prism 210, the combined thickness of prisms 210 changes, thereby changing the extent of refraction of the optical beam. Thus, by moving prisms 210 relative to each other, the optical beam may be selectively targeted onto focusing lens 220 and sample platform 230. The size of prisms 210 is dictated by the lateral coverage of the sample size of interest. In an exemplary embodiment, prisms 210 may be made out of glass with refractive index around 1.5. Two dimensional sample scanning may be achieved by using two sets of these prisms. Movable axis 215 of one set of prisms is rotated 90 degrees from that of the other set of prisms in order to provide two orthogonal scanning capabilities.

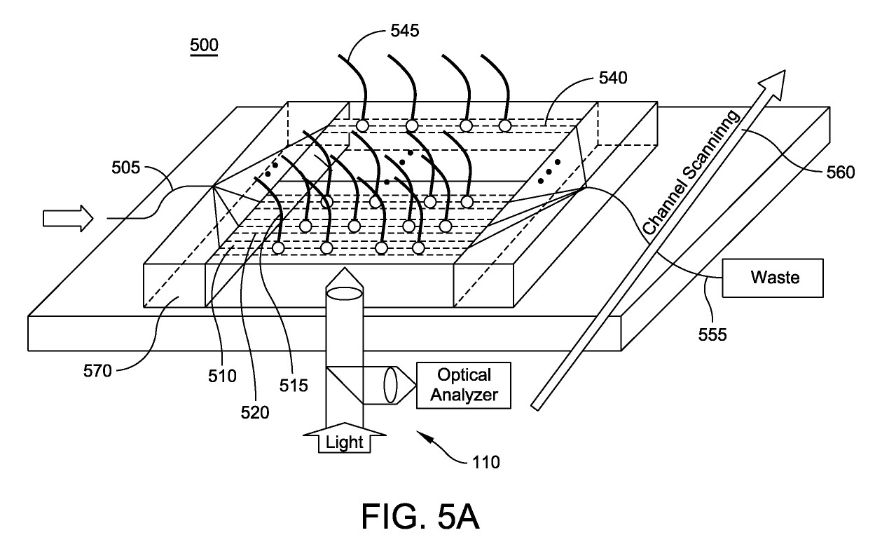

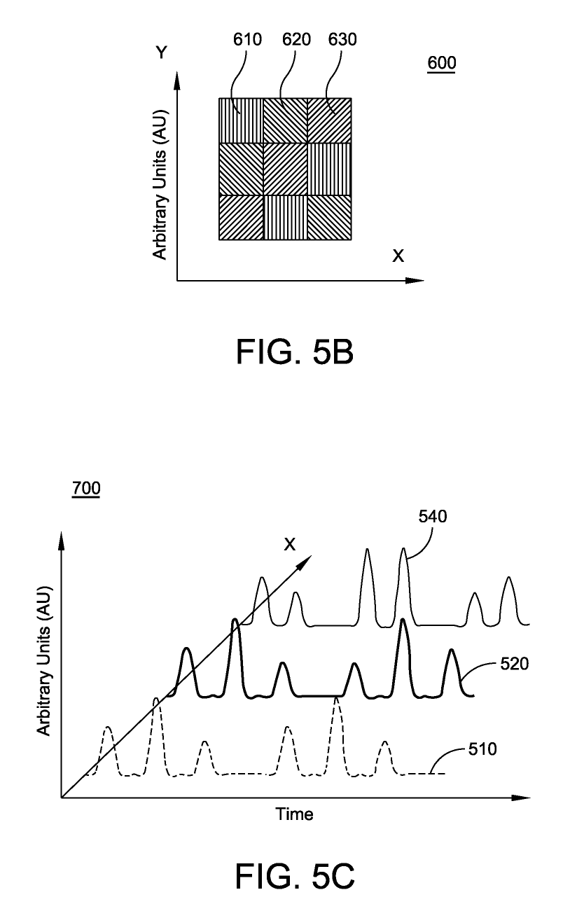

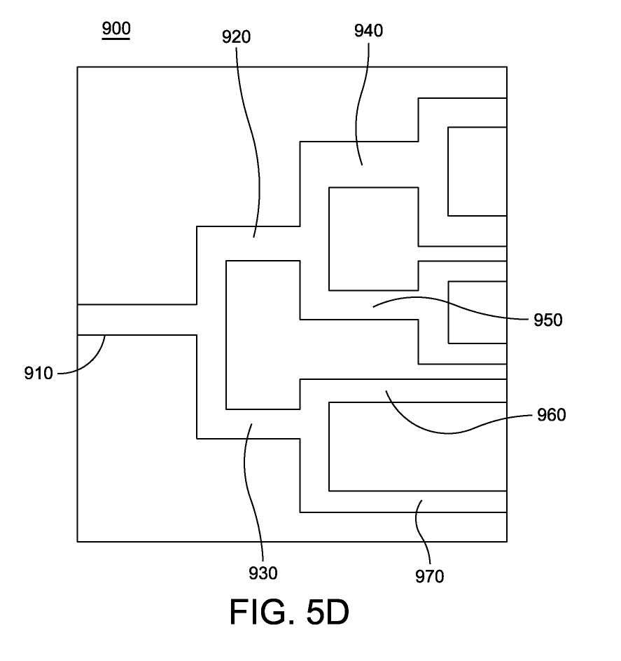

In another exemplary embodiment, shown in FIG. 2B, a pair of steering mirrors 240, 250 of mechanism 260 may be used to steer an optical beam onto different locations of focusing lens 220 and onto different locations on or channels in a sample module 500 (of FIG. 5A), without moving optical probe 110 or sample platform 230. Steering mirrors 240, 250 may be controlled by a micro-electromechanical system (MEMS)-based steering module (not shown). As is known in the art, two-dimensional (2D) and three-dimensional (3D) MEMS-based steering mirrors have been developed for applications in the telecom industry and may be used in optical probe 110. The MEMS-based module (not shown) may be controlled by controller 195 (of FIG. 1) to appropriately position mirrors 240, 250 to selectively focus an optical beam onto different locations of focusing lens 220 and sample platform 230. Mechanisms 200, 260 may be used to focus optical beams or energy on one or more channels of sample module 500 (of FIG. 5A), which facilitates monitoring of multiple channels or different locations of a single channel using a single optical probe 110 without moving optical probe 110 or sample platform 230.

It is contemplated that a configuration of a portable optical probe 110 may include both a mechanical stage and an optical head movably coupled to the mechanical stage as well as an optical beam steering and focusing mechanism in the optical head. Such a configuration may allow a selective use of movable optical head without the use of beam steering and focusing mechanism or another selective use of beam steering and focusing mechanism without moving the optical head, or a combination thereof. A combination of beam steering and optical head translation may be used to extend the spatially scanning range of optical probe 110.

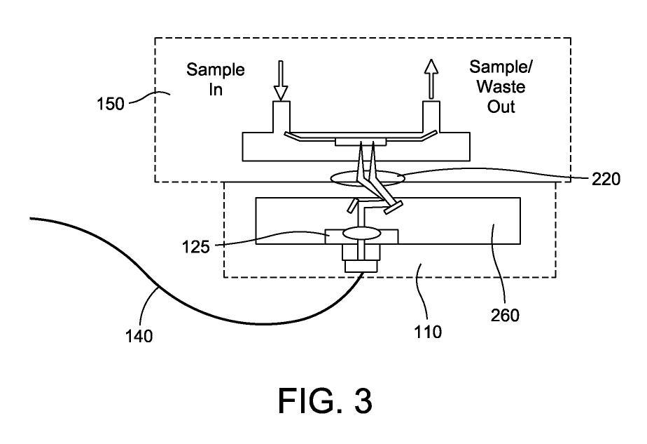

Now referring to FIG. 3, an exemplary embodiment of an optical probe 110 is illustrated. In the illustrated embodiment, optical probe 110 includes a scanning optical head 125. Optical head 125 includes a beam steering and focusing mechanism 260 illustrated in FIG. 2B. The use of beam steering and focusing mechanism 260 eliminates the need for a mechanical or translation stage 120 illustrated in FIG. 1. Mechanism 260 may be used to steer an optical beam onto a selected location on focusing lens 220 and a selected location on sample module 150 therefrom to obtain a spatial probing of the sample in sample module 150. Scanning optical head 125 is, thus, adapted to scan sample module 150 in a selective pattern. The use of scanning optical head 125, therefore, facilitates imaging of multiple channels of a sample module 500 (of FIG. 5A) by using a single moving optical head 125. Scanning optical head 125 is adapted to provide a spatial image of a sample in sample module 150 (of FIG. 1) of 500 (of FIG. 5A) as well as a temporal image wherein a sample in sample module 150 (of FIG. 1) or 500 (of FIG. 5A) may be monitored over a given time period. In the illustrated embodiment, scanning optical head 125 includes MEMS-based beam steering mechanism 260 of FIG. 2B. Optical probe 110 is optically coupled via connectorized optical element 140 to light source 170 (of FIG. 1) and optical coupler 160 (of FIG. 1).

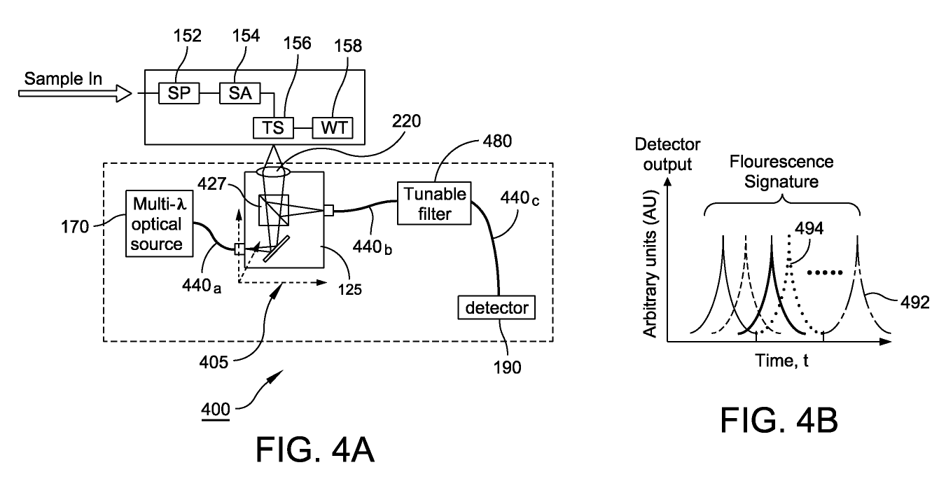

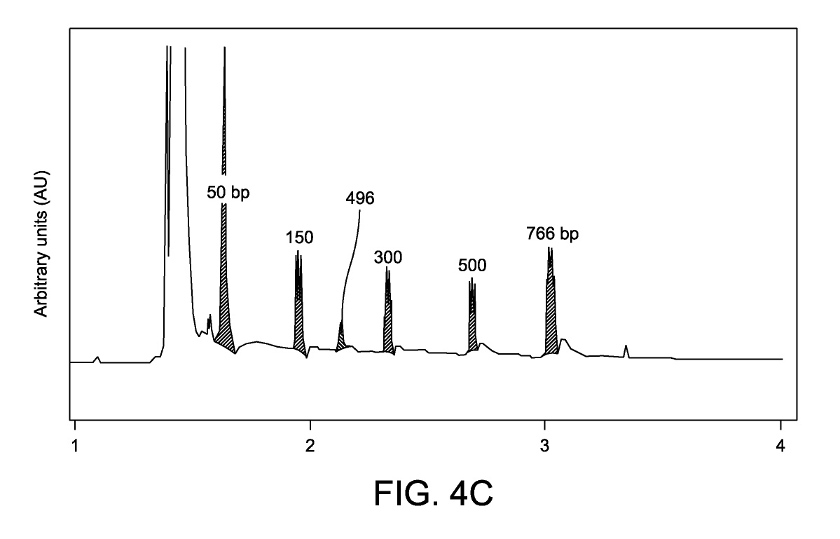

Referring now to FIG. 4A, a system 400 for fluorescence interrogation of a sample is illustrated. System 400 includes a scanning optical head 125. Scanning optical head 125 is adapted to scan along any of the three directions indicated by the reference axes 405. In one configuration, optical head 125 is a bulk-optic head. In another configuration, optical head 125 may be a micro-optic head. Optical head 125 is in optical communication with a light source 170 via connectorized optical element 440ₐ. Optical element 440ₐ is releasably coupled to optical head 125 and light source 170, as described above. Optical head 125 includes a beam spectral splitter 427. Thus, beam spectral splitter 427 may be a part of optical head 125, in one configuration, or may be separated from optical head 125 and be releasably optically connected as illustrated in the configuration of FIG. 1. Beam spectral splitter 427 transmits an optical signal or beam received from light source 170 to focusing lens 220 whereas reflects fluorescence received from the sample to tunable filter 480. In the bulk-optic configuration, splitter 427 performs the same functions as those of optical coupler 160 in FIG. 1 and optical element 140a is replaced by a direct free space coupling of target sample module 150 and splitter 427. Optical head 125 is also optically coupled to a tunable filter 480 via connectorized optical element 440_{b}. Filter 480 is releasably optically coupled to gain detector 190 via connectorized optical element 440_{c}. Connectorized optical elements 440_{b}, 440_{c} are also releasably coupled to the respective connectors of filter 480 and gain detector 190, as described above. The micro-optic head approach provides a higher degree of modularity in system integration and other benefits such as packaging flexibility, system weight reduction and portability requirements.

System 400 further includes a sample module 150. In an exemplary embodiment, sample module 150 takes the form of a micro-channel sample processor. In another embodiment, sample module 150 may be a lab-on-a-chip target extractor. As is known in the art, a lab-on-a-chip (LOC) may have a size ranging from about a few millimeters to about a few centimeters. LOC sample module is adapted to handle extremely small fluid volumes of sample down to about a few pico liters. One or more channels in sample module 150 may be fed with different samples, which enable the use of a single sample module 150 and a single optical probe 110 to monitor and image multiple channels of sample module 150. In an exemplary embodiment, sample module 150 is made of a transparent material, such as glass or plastic such as poly (methyl methacrylate) (PMMA) or Polyethylene terephthalate (PET), to enable optical interrogation of and fluorescence detection from a sample fluid.

In one configuration, sample module 150 includes a sample preparation (SP) section 152, a sample amplification (SA) section 154, a target separation (TS) section 156, and a waste trap (WT) 158. Thus, pre-treatment steps, such as cleaning and separation steps, which are usually performed in a laboratory, are integrated in sample module 150. It will be understood by one skilled in the art that one or more these sections may be omitted or modified based on the requirements of a given application. For example, if the application is a DNA analyzer, the DNA sample is amplified using polymerase chain reaction (PCR) in sample amplification section 154. In another application, the sample may be amplified in the sample amplification section 154 using insulator based dielectrophoresis (iDEP). Some exemplary sample preparation processes which may be performed in sample preparation section 152 include: lysis of target molecules in the case of DNA amplification (PCR), and protein separation/purification in the case of immunoassays. Some exemplary sample amplification processes which may be performed in sample amplification section 154 include PCR and iDEP, and incubation with specific antibodies or antigens for immunoassays. An exemplary target separation process which may be performed in target separation section 156 includes electrophoresis in PCR analysis to separate amplified DNA fragments by size. In an exemplary embodiment, waste trap 158 is adapted to dispose of lysis buffers, rinse/washing buffers, and used reagents in both PCR and immunoassays. Focusing lens 220 of optical probe 110 focuses optical beams onto target separation section 156 to induce fluorescence from the sample present in section 156. The distance between sample module and optical probe 110 depends on various factors, such as the focal length of focusing lens 220, and the wavelength of the optical beam incident on the target. In an exemplary embodiment, optical probe 110 may be positioned at a distance of about 1 mm to about 3 mm from sample module 150 for high collection efficiency of fluorescent emission with proper lens 220.

FIG. 4B illustrates exemplary fluorescence signatures 492, 494 as detected by gain detector 190. As is customary in the art, the Y-axis represents Arbitrary Units (AU) and may represent, by way of non-limiting example only, Volts and Amperes, or other output values from gain detector 190, which output is indicative of the fluorescence signature of one or more targets in the sample. By way of non-limiting examples, X-axis may represent time or spatial mapping of a channel 510 (of FIG. 5). Signatures 492, 494 indicate the presence of different targets in the sample, separated according to their sizes and different flow rates. Likewise, FIG. 4C illustrates another exemplary fluorescence signature 496 of an Anthrax DNA segment detected by detector 190. A database or library of fluorescence signatures may be developed by interrogating a plurality of known agents by illuminating the known agents with an optical signal of predetermined wavelengths to induce fluorescence therefrom. The unique fluorescence signatures emitted by each of the known agents may be stored in memory (e.g. database or library). The database is thereby populated with fluorescence signatures uniquely associated with known agents. A fluorescence signature detected by detector 190 may be used to identify an agent based on the database of known agents and their associated unique fluorescence signatures. The database may be accessible to processor 195.

Referring now to FIG. 5A, there is illustrated a microfluidic chip 500 with multiple channels, according to an embodiment of the invention. Chip 500 has a transparent housing 570 for enabling optical interrogation of the sample contained therewithin. Transparent housing 570 also enables the transmission of fluorescence emission from the sample to optical head 110. In an exemplary embodiment, housing 570 may be fabricated from PMMA or PET or other suitable transparent polymer or glass. Chip 500 includes an inlet channel 505 and an outlet channel 555. In one configuration, inlet channel 505 is adapted to feed one or more samples to multiple channels 510, 520, . . . 540. In other configurations, each channel 510, 520, . . . , 540 may have a respective dedicated inlet channel 505. The sample and/or waste may be collected in outlet channel 555 connected to channels 510, 520, . . . 540, in one configuration. In other configurations, each channels 510, 520, . . . 540 may have a respective dedicated outlet channel 555. In an exemplary embodiment, channel 510 has one or more valves 515. Valve 515 may be adapted to inject reagent, for example, into channel 510. A scanning optical probe 110 is illustrated schematically. An arrow 560 represents the scanning direction of optical probe 110, whereby one or more samples contained in channels 510, 520, . . . 540 are sequentially scanned by optical probe 110.

Now referring to FIG. 5D, there is illustrated a plan view of a microfluidic chip 900 with multiple channels, according to another embodiment of the invention. Chip 900 includes an inlet channel 910, which branches into first and second channels 920, 930. Each of first and second channels 920, 930 further branches into channels 940, 950 and 960, 970 respectively. In one configuration, chip 900 may also include one or more valves 515 (of FIG. 5A). As set forth above, valve 515 may be adapted to inject reagent, for example, into a selected section of channels 910, 920, . . . 960, 970. In the illustrated embodiment, chip 900 has a single inlet channel 910 and multiple outlet channels. In other embodiments, chip 900 may have a single inlet channel 910 and a single outlet channel.

Referring now to FIG. 5B, a plot 600 depicting an exemplary schematic response of an optical interrogation of a microfluidic chip of FIG. 5A having multiple channels scanned by scanning optical probe 110 is illustrated. Plot 600 indicates the variation in the fluorescence emitted by the samples in different channels as well as in different portions of a single channel. For example, blocks 610, 620, 630 schematically illustrate different fluorescence signatures emitted by different sections of a single channel 510 (of FIG. 5A). In the illustrated example, block 610 represents the presence of a given agent in sample contained in a first section of channel 510 (of FIG. 5A). Block 620 represents the presence of the given agent and another reagent injected into channel 510 (of FIG. 5A) via a valve 515 (of FIG. 5A) whereas block 630 represents the presence of the given agent and yet another reagent injected into channel 510 (of FIG. 5A) via another valve 515 (of FIG. 5A).

Now referring to FIG. 5C, a time response plot 700 depicting an exemplary response of an optical interrogation of one or more samples contained in microfluidic chip 500 of FIG. 5A having multiple channels scanned by scanning optical probe 110 is illustrated. Plot 700 illustrates temporal response of the samples in three channels 510, 520, 540 as captured by scanning optical probe 110. In an exemplary embodiment, the temporal response may be indicative of the fluorescence emitted by the sample over a pre-set period of time responsive to an optical signal from optical probe 110.

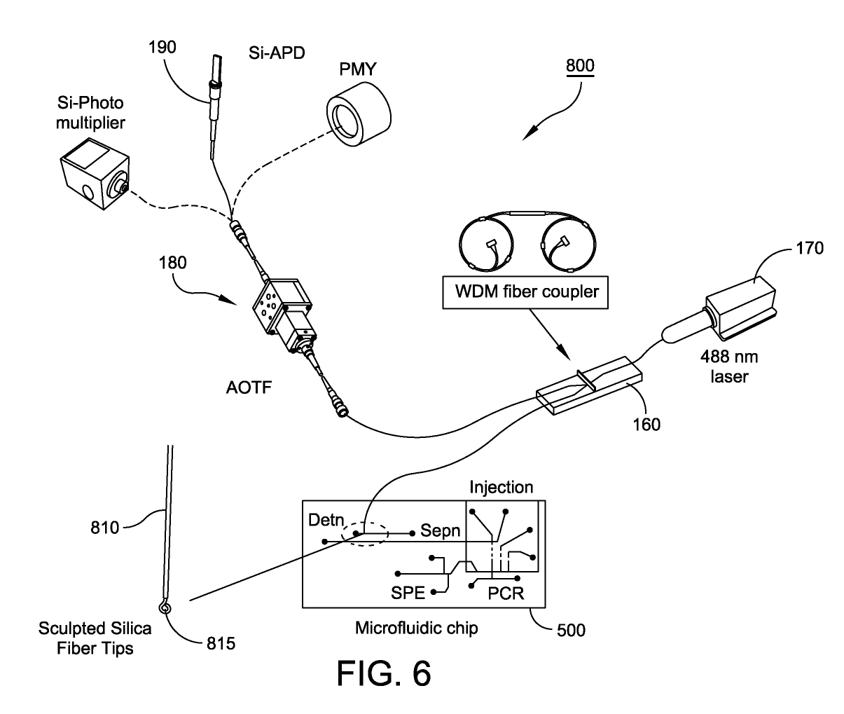

Referring now to FIG. 6, another exemplary modular system 800 for chemical or biological target diagnosis and detection using fluorescence signature detection, according to an embodiment of the invention. Components of system 800 are similar to the components of system 100 of FIG. 1 and are optically, releasably coupled using flexible connectorized optical elements 140 illustrated in FIG. 1. In the illustrated embodiment, system 800 includes a micro-optic fluorescent probe 810. In one configuration, probe 810 includes an integral optical fiber with a lens tip 815 fabricated, for example, by a glass fiber drawing technique. Probe 810 is adapted to selectively scan one or more channels 510, 520, . . . , 540 in chip 500 (of FIG. 5A). Fiber tip 815 is adapted to focus optical signal on the sample in chip 500 (of FIG. 5A), for example, by sculpting to form narrow tip 815 with lensing capability. Fiber tip 815 is also adapted to receive the fluorescence emitted by the sample in chip 500 (of FIG. 5A). In an exemplary embodiment, fiber tip 815 may be sculpted to have a lens size ranging from greater than about 500 nm to about 10,000 nm wherein a larger lens will have higher collection efficiency of the fluorescent emission. In an exemplary embodiment, fiber tips 815 may be fabricated from silica. An advantage of using fiber tip 815 in probe 810 is the resulting compactness of probe 810. Sample scanning can be provided by mechanically moving fiber tip 815 relative to chip 500 (of FIG. 5A).

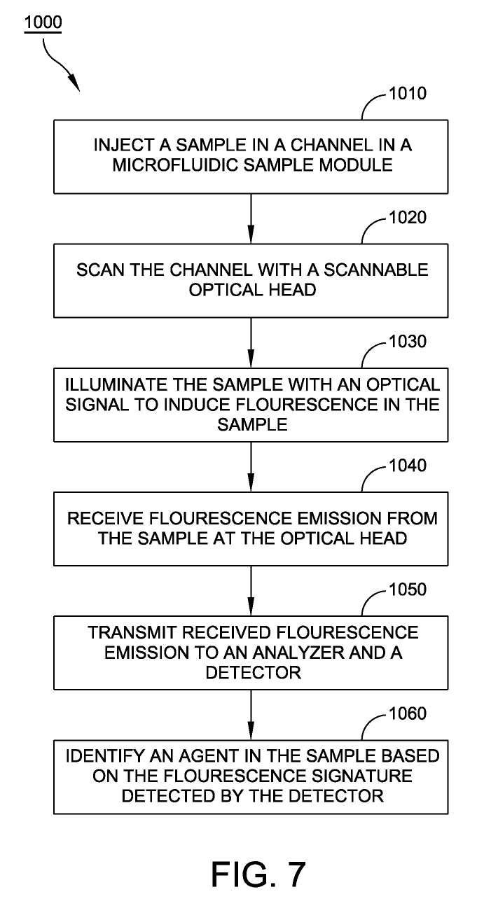

Referring now to FIG. 7, a process flow 1000 for optical interrogation of an agent using system 100 (of FIG. 1) and microfluidic chip 500 (of FIG. 5A) is described, according to an aspect of the invention. At block 1010, a sample is injected in channel 510 (of FIG. 5A) of microfluidic chip 500 (of FIG. 5A). Channel 510 (of FIG. 5A) is scanned with a scanning optical head 125 (of FIG. 5A), at block 1020. At block 1030, the sample in channel 510 (of FIG. 5A) is illuminated with an optical signal containing one or more specific wavelengths intended to elicit an particular optical output or response from the sample for subsequent detection and determination by analyzer 180 (of FIG. 1), gain detector 190 (of FIG. 1) and processor 195 (of FIG. 1). The optical signal is, transmitted from a light source 170 (of FIG. 1) to optical head 125 (of FIG. 5A) via optical elements 140_{b}, 140ₐ (of FIG. 1). The fluorescence emission induced in the sample by incident optical signal is received by optical head 125 (of FIG. 5A), at block 1040. At block 1050, the received fluorescence emission is transmitted from optical head 125 (of FIG. 5A) to analyzer 180 (of FIG. 1) and gain detector 190 (of FIG. 1) via optical coupler 160 and flexible optical elements 140ₐ, 140_{c}, 140_{d}. Analyzer 180 analyzes the spectral composition of the received fluorescence emission and gain detector 190 detects the fluorescence signature contained within the received fluorescence emission. At block 1060, one or more agents in the sample are identified by processor 195 based on the fluorescence signatures detected by gain detector 190 (of FIG. 1). Processor 195 compares one or more fluorescence signatures detected by gain detector 190 with the fluorescence signatures contained in a database of unique fluorescence signatures associated with known agents, as described earlier, to identify one or more known targets in the sample.

An advantage of the system described above is its modular layout. The modular layout facilitates use of the modules in different combinations depending on the demands of the application. Any given module, such as a light source or an analyzer, may be easily replaced with a suitable module to fulfill the application requirements, rendering the system more versatile than the conventional laboratory based systems. As the different modules are connected to each other using flexible optical elements, some of the components may be remotely positioned. For example, a portable, hand-held optical probe has a greater degree of freedom relative to the other modules such as the light source and the analyzer. The use of compact light sources and detectors also result in a small footprint and light weight system. The use of optical beam steering and focusing mechanism as described above herein may eliminate the need for bulky mechanical or translational stages, thereby further reducing the footprint of the system.

Yet another advantage of the system described herein is that the use of LOC sample module reduces required sample volume and minimizes sample platform size and weight. The system described above may be used for DNA fingerprint identification, cytometry, microscopy and fluorescence imaging. Another advantage of the compact system with micro-optic fluorescence probe described herein is the size and weight reduction. Yet another advantage of the use of a multi-channel microfluidic chip is that multiple channels containing one or more samples may be almost simultaneously interrogated optically.

While the foregoing invention has been described with reference to the above-described embodiments, various modifications and changes can be made without departing from the spirit of the invention.

What is claimed is:

1. A portable optical probe comprising:
a mechanical stage, said stage adapted to receive a sample module containing a sample; and
a scanning optical head movably coupled to said mechanical stage, wherein said scanning optical head comprises:
a focusing lens adapted to focus an optical signal received from a light source onto the sample in the sample module, thereby inducing fluorescence emission from the sample, and
a beam splitter adapted to reflect the fluorescence emission from the sample received at said focusing lens to an optical element in optical communication with said beam splitter.

2. The optical probe of claim 1, wherein said scanning optical head comprises a beam steering mechanism.

3. The optical probe of claim 2, wherein said beam steering mechanism comprises a first pair of steering prisms for focusing said optical signal onto said focusing lens.

4. The optical probe of claim 3, wherein said beam steering mechanism comprises a second pair of steering prisms,

5. The optical probe of claim 4, wherein the movable axis of said second pair of steering prisms is generally perpendicular to the movable axis of said first pair of steering prisms.

6. The optical probe of claim 2, wherein said beam steering mechanism comprises a pair of steering mirrors for focusing said optical signal onto said focusing lens.

7. The optical probe of claim 6, further comprising a micro-electromechanical system-based steering module for controlling said pair of steering mirrors.

8. A modular system for optical diagnosis of a sample, said system comprising:
a portable scanning optical probe;
a light source;
a first optical element releasably, optically coupling said scanning optical probe to said light source;
wherein said optical probe receives an optical signal from said light source via said first optical element and directs said optical signal onto the sample,
a filter for transmitting said optical signal from said light source to said optical probe;
a second optical element releasably, optically coupling said filter to said optical probe;
a gain detector; and
a third optical element releasably, optically coupling said gain detector to said filter,
wherein said scanning optical probe comprises:
a fiber tip adapted to transmit an optical signal onto a sample module containing a sample, thereby inducing fluorescence emission from the sample, and to receive said fluorescence emission from the sample,
wherein said optical probe transmits said fluorescence emission to said filter via said second optical element,
wherein said filter reflects said fluorescence emission received from said optical probe to said gain detector, and
wherein said gain detector outputs a signal indicative of a fluorescence signature of a target contained in the sample detected from the received fluorescence emission.

9. The system of claim 8, wherein said filter comprises a dichroic filter.

10. The system of claim 8, wherein said gain detector comprises at least one of a photomultiplier tube and an avalanche photodiode.

11. The system of claim 8, further comprising an analyzer for examining the spectral composition of said received fluorescence emission, said analyzer optically coupled to said filter on a first end thereof and to said gain detector on a second end thereof.

12. The system of claim 11, wherein said analyzer comprises at least one of an acousto-optic tunable filter and a set of fiber Bragg gratings.

13. The system of claim 8, further comprising a sample module for containing the sample.

14. The system of claim 13, wherein said sample module comprises at least one of a micro-channel sample processor and a lab-on-a-chip target extractor.

15. The system of claim 13, wherein said sample module has a transparent housing for enabling optical interrogation of and fluorescence detection from the sample contained in said sample module.

16. The system of claim 13, wherein each of said optical probe, said light source, said filter, and said gain detector includes an optical connector for receiving and releasably securing a connectorized end of said first, second and third respective optical elements.

17. The system of claim 16, wherein said optical connector comprises at least one of LC connector, SC connector and MT connector.

18. A method for optical interrogation of a sample contained in a microfluidic chip, said method comprising the steps of:
injecting a sample in a channel of the microfluidic chip;
scanning the channel containing the sample with a scanning optical probe releasably, optically coupled to a light source;
inducing fluorescence emission in the sample by illuminating the sample with an optical signal received from the light source;
receiving the fluorescence emission from the sample at said scanning optical probe releasably, optically coupled to an optical analyzer and a gain detector; and
transmitting the received fluorescence emission to the optical analyzer and said gain detector.

19. The method of claim 18, wherein said inducing fluorescence comprises illuminating the sample with either a single wavelength optical signal or a multiple wavelength optical signal.

20. The method of claim 18, wherein said inducing fluorescence comprises illuminating the sample with the optical signal focused by a beam steering mechanism.

21. The method of claim 18, wherein said channel of the microfluidic chip comprises a plurality of channels.

22. The method of claim 21, wherein a different sample is injected in each of said plurality of channels.

23. The method of claim 18, further comprising the steps of:
spectrally analyzing the received fluorescence emission using said optical analyzer; and
detecting a fluorescence signature of a target contained in the sample using said gain detector.

24. The method of claim 23 further comprising the step of comparing, by a processor, the detected fluorescence signature with a database of fluorescence signatures, accessible to said processor, for identifying one or more known targets contained in the sample.
